(19) United States
(12) Patent Application Publication
(10) Pub. No.: US 2025/0053466 A1
(43) Pub. Date: Feb. 13, 2025

(54) Edge Application Processing Interface Exporter

(71) Applicant: Cisco Technology, Inc., San Jose, CA (US)

(72) Inventors: Andre Jean Marie Surcouf, Saint Leu La Foret (FR); Trevor Adam Whinmill, Nuneaton (GB); Benjamin William Ryder, Lausanne (CH)

(21) Appl. No.: 18/366,860

(22) Filed: Aug. 8, 2023

(51) Int. Cl. G06F 9/54

(52) U.S. Cl. CPC G06F 9/547

(57) ABSTRACT

In one embodiment, a method may receive a first notification message associated with an instance of an edge application at an edge site of an edge network. The method may receive a subset of a unique identifier associated with the instance of the edge application from an application processing interface (API) router agent associated with the edge application. The method may use the subset of the unique identifier to determine a complete unique identifier associated with the instance of the edge application. The method may generate a second notification message corresponding to an API call using the complete unique identifier. The method may determine a network connection with the API router agent associated with the edge application. In response to determining the network connection is stable, the method may expose the second notification message to the API router agent associated with the edge application.

### TECHNICAL FIELD

The present disclosure relates generally to edge applications for a distributed edge computing process, and more particularly, to determining a bidirectional notification mechanism related to weak network connectivity of application interface (API) calls for a plurality of edge devices.

### BACKGROUND

Distributed edge computing is a decentralized information technology (IT) architecture in which the computing resources, such as servers, computing nodes, storage devices, and network equipment, are deployed at the edge of the network close to a user equipment, near an originating source, such as an edge device. In cloud computing, the data is typically processed and stored in large-scale, remote data centers or the cloud. Thus, the cloud computing has issues associated with bandwidth, latency, and security associated with a plurality of edge devices, such as in an Internet of Things (IoT) network or a larger stack edge setup. However, it is possible to use distributed edge computing to improve bandwidth efficiency for a large amount of data from edge applications of the plurality of edge devices that are usually close to the edge of the network. It is desired to develop a mechanism to communicate with each other and collaborate to perform tasks for the plurality of edge devices.

### BRIEF DESCRIPTION OF THE DRAWINGS

FIG. 1 illustrates an example edge application processing interface (API) exporter system for use in a product.

FIG. 2 illustrates an example edge computing control system.

FIG. 3 illustrates an example method for determining a bidirectional API communication mechanism for API calls based on network connectivity.

### DESCRIPTION OF EXAMPLE EMBODIMENTS

### Overview

In one or more embodiments, an apparatus may comprise one or more processors, and one or more computer-readable non-transitory storage media coupled the to one or more of the processors. The one or more computer-readable non-transitory storage media may comprise instructions operable when executed by one or more of the processors to cause one or more components of the apparatus to perform operations to receive a first notification message associated with an instance of an edge application at an edge site of an edge network. The apparatus is configured to receive a subset of a unique identifier associated with the instance of the edge application from an API router agent associated with the edge application. The apparatus is configured to determine, using the subset of the unique identifier, a complete unique identifier associated with the instance of the edge application. The apparatus is configured to generate a second notification message corresponding to an API call using the complete unique identifier associated with the instance of the edge application. The apparatus is configured to determine a network connection with the API router agent associated with the edge application. In response to determining the network connection is stable, the apparatus is configured to expose the second notification message to the API router agent associated with the edge application.

In one or more embodiments, a method, by an apparatus, may receive a first notification message associated with an instance of an edge application at an edge site of an edge network. The method may receive a subset of a unique identifier associated with the instance of the edge application from an API router agent associated with the edge application. The method may determine, using the subset of the unique identifier, a complete unique identifier associated with the instance of the edge application. The method may generate a second notification message corresponding to an API call using the complete unique identifier associated with the instance of the edge application. The method may determine a network connection with the API router agent associated with the edge application. In response to determining the network connection is stable, the method may expose the second notification message to the API router agent associated with the edge application.

In one or more embodiments, one or more computer-readable non-transitory storage media may embody software that is operable, when executed by a processor, to receive a first notification message associated with an instance of an edge application at an edge site of an edge network. The software may be further operable, when executed, to receive a subset of a unique identifier associated with the instance of the edge application from an API router agent associated with the edge application. The software may be further operable, when executed, to determine, using the subset of the unique identifier, a complete unique identifier associated with the instance of the edge application. The software may be further operable, when executed, to generate a second notification message corresponding to an API call using the complete unique identifier associated with the instance of the edge application. The software may be further operable, when executed, to determine a network connection with the API router agent associated with the edge application. In response to determining the network connection is stable, The software may be further operable, when executed, to expose the second notification message to the API router agent associated with the edge application.

Technical advantages of certain embodiments of this disclosure may include one or more of the following. Certain apparatus and methods described herein may determine a bidirectional API communication mechanism for API calls based on network connectivity. The apparatus and the method may leverage the bidirectional API communication mechanism for API calls associated with an edge application to support eventually consistent API calls associated with the edge application with additional capabilities related to edge weak network connectivity nature. The apparatus and the method may defer an API call until the network connection is restored. The apparatus and the method may perform the API call based on the nature of the called API within an instantaneous or deferred time period. The apparatus and the method may use a unique identifier to identify each instance associated with the edge application.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In general, distributed edge computing is increasingly becoming a standard edge computing architecture for data processing and data storage closer to where the data originates. Distributed edge computing is increasingly becoming a standard architecture for many use cases, especially those that involve time-sensitive data. Distributed edge computing may process the data, such as workloads, closer to where the data originates and helps reduce latency for real-time analysis of sensor data in an edge network. In particular, the distributed edge computing provides a different paradigm from cloud computing to improve response time and bandwidth efficiency. Millions of devices may at different edge sites of the edge network include one or more edge applications that generate a massive amount sensor data. The cloud computing typically processes workloads from various devices of the edge network in a traditional centralized data center, such as a large-scale, remote data center. With distributed edge computing, decentralized edge nodes are deployed at edge sites close to the edge applications. Because of the proximity in geographical locations between adjacent edge nodes and the use of high-speed network connections, the distributed edge computing may obtain real-time task offloading and resource allocation using computing resources of adjacent edge nodes for the real-time analysis of the sensor data. As another example, a hybrid model of the distributed edge computing and the cloud computer is also possible, whereby some processing is done at the edge and other processing takes place in the cloud. Therefore, the distributed edge computing may provide an optimized reliability and may balance the use of edge node cluster resources among edge computing nodes.

In an embodiment, each edge site within the edge network may suffer from poor or intermittent network connectivity while communicating with applications running at the edge, which are not reliable and prone to error. An edge API exporter system may be configured to dynamically manage each edge application at an edge site to expose an API to an external world, such as a cloud control plane or another edge site, during different edge proxy life cycles. For example, the edge API exporter system may be an API proxy system as a control plane component of the edge network that carries signaling traffic and is responsible for network routing. As another example, the edge API exporter system may include a communication protocol, such as a web socket, to facilitate communication between different components, such as control planes, data planes, application load balancers, etc. In particular, a control plane may act as a stoplight in communication traffic to control how data packets are forwarded from one place to another place. For example, the control plane may create a routing table that stores different network paths identified by routers based on various protocols, such as border gateway protocol (BGP), open shortest path first (OSPF), enhanced interior gateway routing protocol (EIGRP), intermediate system to intermediate system (IS-IS), etc. As another example, the data plane may determine how data packets should be forwarded from one place to another place in communication traffic. As another example, the application load balancer may distribute incoming application traffic to applications across multiple servers to ensure no single server bears too much demand. Therefore, the edge API exporter system may provide any service level agreement (SLA) guarantees to implement communication protocols for various applications at each edge site of the edge network.

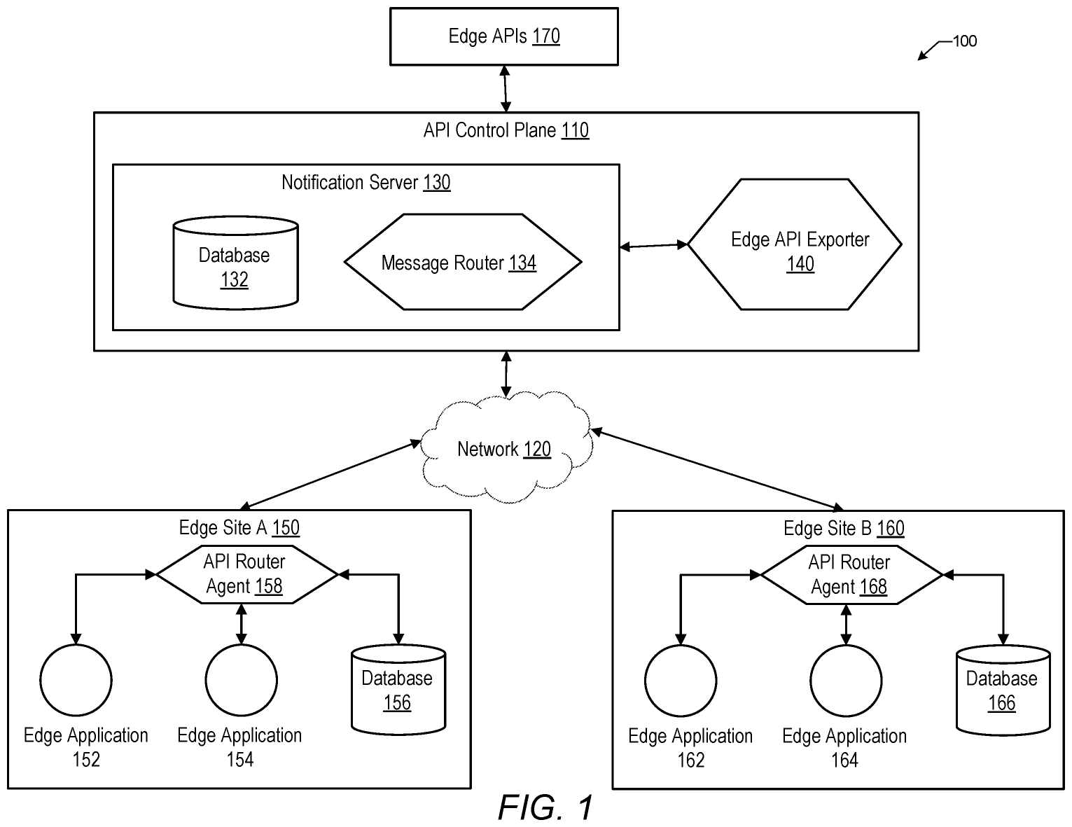

FIG. 1 illustrates an example edge application processing interface (API) exporter system 100 for use in a product. In embodiments, the edge API exporter system 100 may include an API control plane 110, network 120, one or more edge sites, such as edge site A 150 and edge site B 160. Each edge site may include an API router agent connected to a plurality of edge applications, such as API router agent 158 connected to edge application 152 and edge application 154 for edge site A 150, API router agent 168 connected to edge application 162 and edge application 164 for edge site B 160. In particular, the API control plane 110 may be configured to include a notification server 130 and an edge API exporter 140. For example, the API control plane 110 may be communicatively coupled to network 120 to routinely collect huge amounts of data packets from a plurality of edge applications associated with edge devices operating in real time in the edge network. Instead of transmitting the data packets to a centralized data center for processing and analysis, the edge API exporter system 100 may be configured to convey API calls and corresponding responses between the one or more edge sites and the API control plane 110 in order to efficiently perform the work near the edge sites where the data packets are actually generated. As another example, the API control plane 110 may be a control API communicatively coupled to network 120 to locally perform the work near the edge sites using data from or to the plurality of applications within the edge network. As another example, the API control plane 110 may be communicatively coupled to network 120 to call an API exposed in the cloud by the edge API exporter using locally stored data which is outputted from the plurality of applications within the edge network. As a result, the API control plane 110 may provide an interface to at least a network server component to determine a priority queue of data traffic from or to the one or more edge sites. In particular, the API control plane 110 may provide a classification of service for the data traffic from or to the one or more edge sites.

Network 120 broadly represents any wireline or wireless network, using any of satellite or terrestrial network links, such as public or private cloud on the Internet, local area networks (LANs), metropolitan area networks (MANs), wide area networks (WANs), a public switched telephone network (PSTN), campus network, internetworks, or combinations thereof. The network 120 may include or comprise the public internet and networked server computers that implement Web2 and/or Web3 technologies. The network 120 may comprise or support intranets, extranets, or virtual private networks (VPNs). The network 120 may also comprise a public switched telephone network (PSTN) using digital switches and call forwarding gear. The network 120 may also comprise a public switched telephone network (PSTN) using digital switches and call forwarding gear.

In an embodiment, the API control plane 110 may reside close to the edge site, such as edge site A 150 or edge site B 160, within the edge network where the API router agents and edge applications generate the data traffic. The API control plane 110 may be configured to support eventually consistent API calls with additional capabilities related to edge weak network connectivity nature. For example, the API control plane 110 may determine how data packets from an edge application, such as edge application 152, edge application 154, edge application 162, or edge application 164, may be stored and processed locally within the edge network. As another example, the API control plane 110 may determine how the data packets from the edge application, such as edge application 152, may be exposed to one or more APIs, such edge APIs 170. In particular, the API control plane 110 may obscure or secure any sensitive data in the collected data packets from the edge application before forwarding the collected data packets from one place to another place, such as a cloud or a primary data center, within the edge network. When the edge network suffers from weak network connectivity, the API control plane 110 may delay the edge APIs 170 until the network connection is restored. Therefore, the API control plane 110 may balance the API calls, such as edge APIs 170, associated with the plurality of edge applications from an edge application caller perspective. The API control plane 110 may respond to the edge API calls depending on the nature of the called edge APIs 170. For example, the API control plane 110 may defer the response to an API call when the network connection is weak or not stable. The deferred response is independent from the action resulting from the API call to be deferred. As another example, the API control plane 110 may react to the API call as a direct API call in an instantaneous or quasi-instantaneous response time.

In an embodiment, the API control plane 110 may be configured to communicate with any edge application using a unique identifier. The unique identifier may include a tenant identifier of tenant_id, a site identifier of site_id, a unique application identifier of app_id, a unique deployment identifier of deployment_id, and an instance number of instance_number. For example, each edge application is associated with a unique application identifier, such as app_id. Thus, each deployment of an edge application may receive a unique deployment identifier, such as deployment_id. If the edge application is a daemon set or a stateful set, each site local instance also receives an instance number, such as instance_number. Therefore, the API control plane 110 may identify each running application by its corresponding unique identifier across the whole system. An example of a unique identifier of an edge application may be found in Table 1 below.

TABLE 1
An example of unique identifier of an edge application.

| Description | Label |
|---|---|
| Tenant Identifier | Tenant_id |
| Site Identifier | Site_id |
| Unique Application | App_id |
| Identifier | |
| Unique Deployment | Deployment_id |
| Identifier | |
| Instance Number | Instance-number |
| End-point | Application-end-points |
| Unique Identifier (URL) | https://great.bear.ip/app_id/site_id/deployment_id/[instance- |
| | number]/<application-end-points> |

In an embodiment, each edge site may use a database to locally store a subpart of unique identifiers associated with a plurality of edge applications for a corresponding edge site. For example, edge site A 150 may locally store the unique deployment identifier and the instance number associated with each of the edge applications, such as edge application 152 and edge application 154, in a database, such as database 156, associated with edge site A 150. As another example, edge site B 160 may locally store the unique deployment identifier and the instance number associated with each of the edge applications, such as edge application 162 and edge application 164, in a database, such as database 166, associated with edge site B 160. Furthermore, each edge site may be configured to include a local API router agent to report the subpart of unique identifiers to the API control plane 110. For example, the API router agent 158 at edge site A 150 may transmit the unique deployment identifier and the instance number associated with edge application 152 and edge application 154 to the notification server 130. As another example, the API router agent 168 at edge site B 160 may transmit the unique deployment identifier and the instance number associated with edge application 162 and edge application 164 to the notification server 130. In response to receiving the subpart of unique identifiers from an edge site, the notification server 130 may be configured to access the tenant identifier and the site identifier associated with the particular edge site to be combined with the subpart of unique identifiers from the edge site. As a result, the notification server 130 may store the combined information of unique identifiers in a general message router data base, such database 132.

In an embodiment, the notification server 130 may be configured to be coupled to the edge API exporter to leverage a bidirectional notification mechanism based on the unique identifiers associated with the plurality of edge applications for a corresponding edge site. For example, an edge application, such as edge application 152, may send a first notification message to a new control plane internal service extension, such as the API control plane 110. The first notification message contains an API description of one or more edge APIs 170 to expose. In particular, the API description may include protocols and end-points associated with the one or more APIs 170 that are specified for a machine readable interface definition language, such as Open-API. Because the edge APIs 170 are the same for all running instances of the same edge application, such as edge application 152, only the end-point identifier would differ between two different instances associated with the same edge application. The API exporter system 100 may expose the API description for each instance independently. Thus, an instance would ignore other instances when forwarding the API description for the respective edge application. As a result, the API control plane 110 may be configured to use a message router 134 to receive the first notification message to evaluate the API descriptions for a plurality of edge applications. For example, in the first notification message, message router 134 may add an additional end-point corresponding to a new instance based on the API descriptions. The message router 134 may be configured to send the first notification message to the API exporter 140 to generate a complete unique identifier using a Uniform Resource Locator (URL) for each instance of the edge application. In particular, the API exporter 140 may receive an API description either from one running instance of an edge application or indirectly from the API description which includes a Unique Application Identifier app-id to uniquely characterize the edge application. Thus, the running instance may simply notify the API exporter 140 that it is live and the API exporter 140 would use the Unique Application Identifier app-id as part of the instance identity to get the API details from the application API.

In an embodiment, the API exporter 140 may be configured to create a new end-point upon reception of the first notification message from the message router 134. The instance number may be optionally created or not as an edge application decision depending on the API description in the first notification message. In particular, the edge APIs 170 are secure so that they may be accessed only by the tenant owing the edge site.

In an embodiment, the API exporter 140 may be configured to create a second notification message corresponding to an API call, such as edge APIs 170, when such an end-point is called for by the API call. The API exporter 140 may expose the second notification message to a corresponding API router agent, such as API router agent 158 at edge site A 150 or API router agent 168 at edge site B 160. In response to receiving the second notification message, the corresponding API router agent may forward the second notification message to a corresponding edge application for an edge site, such as edge application 152 or edge application 154 for edge site A 150, which is associated with the API call. For example, the API exporter 140 may interpret the communication process as a direct API call when the edge application responds to the end-point called for by the API call within an instantaneous or quasi-instantaneous response time. In particular, the API control plane 110 may directly call one or more local APIs, such as edge APIs 170, exposed by one or more edge applications, such as edge application 152 and edge application 154, as an API proxy would do. As another example, the notification server 130 may evaluate network connectivity associated with the corresponding edge application for the edge site to determine if the second notification message needs to be deferred until the connection with the corresponding edge application for the edge site is restored. The notification server 130 may send a command to the edge API exporter 140 to defer the transmission of the second notification message to the corresponding edge application. As a result, the API exporter system 100 may allow a plurality of edge applications to export API as they would run in a cloud as a traditional web native service. The API exporter system 100 may also allow for exposure of an API for an edge application through a poxy accessible based on unique identifiers associated with the API call and the edge application.

Although FIG. 1 describes and illustrates particular components, devices, or systems carrying out particular actions, this disclosure contemplates any suitable combination of any suitable components, devices, or systems carrying out any suitable actions.

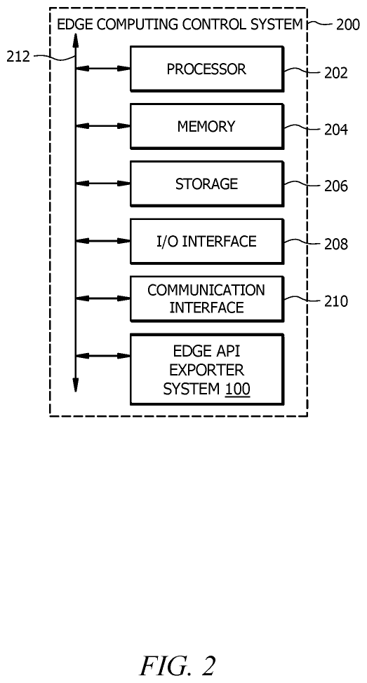

FIG. 2 illustrates an example edge computing control system 200. In particular embodiments, one or more edge computing control systems 200 perform one or more steps of one or more methods described or illustrated herein. In particular embodiments, one or more edge computing control systems 200 provide functionality described or illustrated herein. In particular embodiments, software running on one or more edge computing control systems 200 performs one or more steps of one or more methods described or illustrated herein or provides functionality described or illustrated herein. Particular embodiments include one or more portions of one or more edge computing control systems 200. Herein, reference to an information handling system may encompass a computer or a computing device, and vice versa, where appropriate. Moreover, reference to an information handling system may encompass one or more computer systems, where appropriate. Further, the edge API exporter system 100 in FIG. 1 may be incorporated into the illustrated edge computing control system 200. With reference to the present disclosure, the edge computing control system 200 may be the aforementioned product incorporating edge API exporter system 100, as described above with respect to FIG. 1. As such, “product” and “edge computing control system 200” may herein be used interchangeably.

This disclosure contemplates any suitable number of edge computing control systems 200. This disclosure contemplates edge computing control system 200 taking any suitable physical form. As example and not by way of limitation, edge computing control system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, edge computing control system 200 may include one or more edge computing control systems 200; be unitary or distributed; span multiple locations; span multiple machines; span multiple data centers; or reside in a cloud, which may include one or more cloud components in one or more networks. Where appropriate, one or more edge computing control systems 200 may perform without substantial spatial or temporal limitation one or more steps of one or more methods described or illustrated herein. As an example and not by way of limitation, one or more edge computing control systems 200 may perform in real time or in batch mode one or more steps of one or more methods described or illustrated herein. One or more edge computing control systems 200 may perform at different times or at different locations one or more steps of one or more methods described or illustrated herein, where appropriate.

In particular embodiments, edge computing control system 200 includes a processor 202, memory 204, storage 206, an input/output (I/O) interface 208, a communication interface 210, and a bus 212. Although this disclosure describes and illustrates a particular information handling system having a particular number of particular components in a particular arrangement, this disclosure contemplates any suitable information handling system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, edge computing control system 200 may load instructions from storage 206 or another source (such as, for example, another edge computing control system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to edge computing control system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between edge computing control system 200 and one or more I/O devices. edge computing control system 200 may include one or more of these I/O devices, where appropriate. One or more of these I/O devices may enable communication between a person and edge computing control system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between edge computing control system 200 and one or more other edge computing control systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, edge computing control system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, edge computing control system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Edge computing control system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of edge computing control system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

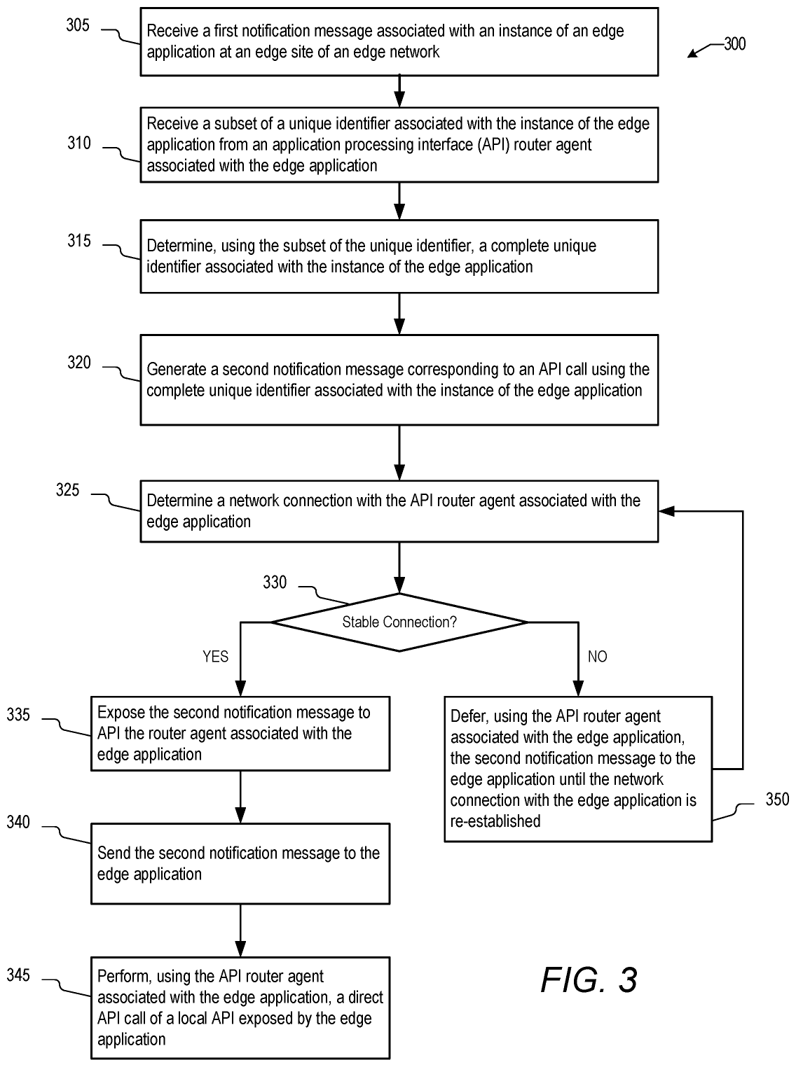

In an embodiment, edge computing control system 200 may be configured to initiate a bidirectional notification process (see FIG. 3) in order to support consistent API calls based on edge network connectivity associated with one or more edge sites associated with the API calls. In an embodiment, edge computing control system 200 may be configured to receive a first notification message associated with an instance of an edge application at an edge site of an edge network. In an embodiment, edge computing control system 200 may be configured to receive a subset of a unique identifier associated with the instance of the edge application from an API router agent associated with the edge application. In an embodiment, edge computing control system 200 may be configured to use the subset of the unique identifier to determine a complete unique identifier associated with the instance of the edge application. In an embodiment, edge computing control system 200 may be configured to generate a second notification message corresponding to an API call using the complete unique identifier associated with the instance of the edge application. In an embodiment, edge computing control system 200 may be configured to determine a network connection with the API router agent associated with the edge application. In response to determining the network connection is stable, edge computing control system 200 may be configured to expose the second notification message to the API router agent associated with the edge application.

FIG. 3 illustrates an example method 300 to use edge API exporter system 100 (referring to FIG. 1) of edge computing control system 200 (referring to FIG. 2) to determine a bidirectional API communication mechanism for API calls based on network connectivity. The method 300 may begin at step 305, where the edge API exporter system 100 may receive a first notification message associated with an instance of an edge application at an edge site of an edge network. In particular, the first notification may include a description of the API to expose by the edge application. For example, the first notification message includes a protocol and an end-point that corresponds to the instance of the edge application. As another example, the description of the first notification message is received in Open-API format.

At step 310, the edge API exporter system 100 may receive a subset of a unique identifier associated with the instance of the edge application from an API router agent associated with the edge application. For example, a unique identifier may include a tenant identifier, a site identifier, a unique application identifier, a unique deployment identifier, an instance number, and an end-point. As another example, the subset of the unique identifier may include the instance identifier and the unique deployment identifier. In particular, each running application may be uniquely identified by a corresponding unique identifier. The edge API exporter system 100 may locally store the subset of the identifier associated with the instance of the edge application at the edge site. Furthermore, the edge API exporter system 100 may use a site local API router agent to access the subset of the unique identifier and store it in a general message router database.

At step 315, the edge API exporter system 100 may use the subset of the unique identifier to determine a complete unique identifier associated with the instance of the edge application. For example, the edge API exporter system 100 may access router data associated with the instance of the edge application. The router data includes the tenant identifier and the site identifier. As another example, the edge API exporter system 100 may determine the end-point corresponding to the instance of the edge application. Based on the router data, the end-point, and the subset of the unique identifier, the edge API exporter system 100 may determine the complete unique identifier associated with the instance of the edge application.

At step 320, the edge API exporter system 100 may generate a second notification message corresponding to an API call using the complete unique identifier associated with the instance of the edge application. For example, the second notification message is an acknowledge message. As another example, the second notification message is associated with an actual call to the API call exposed by the instance of the edge application initiated at step 305. The edge API exporter system 100 may expose the second notification message corresponding to the API call for the edge application to respond to an API router agent. In particular, the edge API exporter system 100 may simply prepare a response to step 305 which would be eventually pulled by the API router agent associated with the edge application at the edge site. At step 325, the edge API exporter system 100 may determine a network connection with the API router agent associated with the edge application at the edge site. For example, the edge API exporter system 100 may determine the edge site has stable network connectivity. As another example, the edge API exporter system 100 may determine the edge site does not have stable network connectivity, but instead has weak network connectivity. In particular, the API router agent may sit behind a network address translation (NAT) traversal or a firewall or an enterprise router. Thus, the edge API exporter system 100 would determine the stability of the network connectivity by measuring the time it takes for the API router agent to pull the response from the API exporter.

At step 330, the edge API exporter system 100 may make a determination whether the edge site has a stable network connection. Where the edge site has a stable network connection, the process may proceed to step 335 to expose the second notification message to the API router agent associated with the edge application. Where the edge site does not have a stable network connection, the process may proceed to step 350 to defer the second notification message to be sent to the API router agent associated with the edge application.

At step 335, the edge API exporter system 100 may send the second notification message to the API router agent associated with the edge application.

At step 340, the edge API exporter system 100 may send the second notification message to the edge application which would respond accordingly.

At step 345, the edge API exporter system 100 may use the API router agent associated with the edge application to perform a direct API call of a local API exposed by the edge application as a proxy would do.

At step 350, the edge API exporter system 100 may use the API router agent associated with the edge application to defer the second notification message to the edge application until the network connection with the edge application is re-established. For example, the API router agent may effectively send information to the API exporter system 100 so the response prepared by the API exporter system 100 would be eventually pulled by the API router agent. As another example, the API router agent associated with the edge application may contact the message router to send a supervision message to the API exporter that the API call needs to be deferred due to a weak network connection. In response to receiving the notification message, the API exporter may react accordingly to balance the workloads to achieve optimized reliability and balance edge node cluster resources use among edge computing nodes.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method to determine a bidirectional API communication mechanism for API calls based on network connectivity, including the particular steps of the method of FIG. 3, this disclosure contemplates any suitable method including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An apparatus, comprising:
one or more processors;
one or more computer-readable non-transitory storage media comprising instructions that, when executed by the one or more processors, cause one or more components of the apparatus to perform operations comprising:
receiving a first notification message associated with an instance of an edge application at an edge site of an edge network;
receiving a subset of a unique identifier associated with the instance of the edge application from an application processing interface (API) router agent associated with the edge application;
determining, using the subset of the unique identifier, a complete unique identifier associated with the instance of the edge application;
generating a second notification message corresponding to an API call using the complete unique identifier associated with the instance of the edge application;
determining a network connection with the API router agent associated with the edge application; and
in response to determining the network connection is stable, exposing the second notification message to the API router agent associated with the edge application.

2. The apparatus of claim 1, wherein the one or more components of the apparatus perform operations further comprising:
in response to determining the network connection is stable, sending the second notification message to the API router agent associated with the edge application to interpret the second notification message as a direct API call for the edge application to respond.

3. The apparatus of claim 2, wherein the one or more components of the apparatus perform operations further comprising:
in response to determining the network connection is stable, performing, using the API router agent associated with the edge application, a direct API call of a local API exposed by the edge application.

4. The apparatus of claim 1, wherein the one or more components of the apparatus perform operations further comprising:
in response to determining the network connection is not stable, deferring, using the API router agent associated with the edge application, the second notification message to the edge application until the network connection with the edge application is re-established.

5. The apparatus of claim 1, wherein the one or more components of the apparatus perform operations further comprising:
determining the complete unique identifier associated with the instance of the edge application using a tenant identifier, a site identifier, a unique application identifier, a unique deployment identifier, an instance number, and an end-point.

6. The apparatus of claim 5, wherein the instance number is optionally created as an edge application decision depending on an API description in the first notification message.

7. The apparatus of claim 5, wherein the one or more components of the apparatus perform operations further comprising:
accessing router data associated with the instance of the edge application, wherein the router data includes the tenant identifier and the site identifier; and
determining an end-point corresponding to the instance of the edge application.

8. The apparatus of claim 7, wherein the one or more components of the apparatus perform operations further comprising:
determining, using the router data, the end-point, and the subset of the unique identifier, the complete unique identifier associated with the instance of the edge application.

9. The apparatus of claim 1, wherein:
the first notification message includes a description of the API to expose and the first notification message includes a protocol and one or more end-points, and
the description of the first notification message is received in Open-API format.

10. The apparatus of claim 1, wherein the API call is secure to be accessed by a tenant owning the edge site.

11. A computer-implemented method, comprising:
receiving a first notification message associated with an instance of an edge application at an edge site of an edge network;
receiving a subset of a unique identifier associated with the instance of the edge application from an application processing interface (API) router agent associated with the edge application;
determining, using the subset of the unique identifier, a complete unique identifier associated with the instance of the edge application;
generating a second notification message corresponding to an API call using the complete unique identifier associated with the instance of the edge application;
determining a network connection with the API router agent associated with the edge application; and
in response to determining the network connection is stable, exposing the second notification message to the API router agent associated with the edge application.

12. The computer-implemented method of claim 11, further comprising:
in response to determining the network connection is stable, sending the second notification message to the API router agent associated with the edge application to interpret the second notification message as a direct API call for the edge application to respond.

13. The computer-implemented method of claim 11, further comprising:
in response to determining the network connection is stable, performing, using the API router agent associated with the edge application, a direct API call of a local API exposed by the edge application.

14. The computer-implemented method of claim 11, further comprising:
in response to determining the network connection is not stable, deferring, using the API router agent associated with the edge application, the second notification message to the edge application until the network connection with the edge application is re-established.

15. The computer-implemented method of claim 11, further comprising:
determining the complete unique identifier associated with the instance of the edge application using a tenant identifier, a site identifier, a unique application identifier, a unique deployment identifier, an instance number, and an end-point.

16. The computer-implemented method of claim 15, wherein the instance number is optionally created as an edge application decision depending on an API description in the first notification message.

17. The computer-implemented method of claim 15, further comprising:
accessing router data associated with the instance of the edge application, wherein the router data includes the tenant identifier and the site identifier; and
determining an end-point corresponding to the instance of the edge application.

18. The computer-implemented method of claim 17, further comprising:
determining, using the router data, the end-point, and the subset of the unique identifier, the complete unique identifier associated with the instance of the edge application.

19. The computer-implemented method of claim 11, wherein:
the first notification message includes a description of the API to expose and the first notification message includes a protocol and one or more end-points, and the description of the first notification message is received in Open-API format.

20. A non-transitory computer-readable medium comprising instructions that are configured, when executed by a processor, to:
receive a first notification message associated with an instance of an edge application at an edge site of an edge network;
receive a subset of a unique identifier associated with the instance of the edge application from an application processing interface (API) router agent associated with the edge application;
determine, using the subset of the unique identifier, a complete unique identifier associated with the instance of the edge application;
generate a second notification message corresponding to an API call using the complete unique identifier associated with the instance of the edge application;
determine a network connection with the API router agent associated with the edge application; and
in response to determining the network connection is stable, expose the second notification message to the API router agent associated with the edge application.
